(19) United States
(12) Patent Application Publication
(10) Pub. No.: US 2026/0044963 A1
(43) Pub. Date: Feb. 12, 2026

(54) METHOD FOR PRECISE AND ACCURATE SEGMENTATION OF A 2D OR 3D IMAGE

(71) Applicant: MAIA MEDICAL TECHNOLOGIES, Saint Martin D'heres (FR)

(72) Inventors: Arnaud CLERE, Saint-Martin-D'heres (FR); Erwan DUVERNAY, Saint-Martin-D'heres (FR)

(73) Assignee: MAIA MEDICAL TECHNOLOGIES, Saint Martin D'heres (FR)

(21) Appl. No.: 19/297,757

(22) Filed: Aug. 12, 2025

(30) Foreign Application Priority Data
Aug. 12, 2024 (FR) 24/08864

(51) Int. Cl. G06T 7/149; G06T 7/143

(52) U.S. Cl. CPC G06T 7/149; G06T 7/143

(57) ABSTRACT

A computer-implemented method for segmenting an image, including (S1) obtaining a 2D/3D image I of a region of interest; (S2) performing an initial segmentation of the 2D/3D image I; (S3) processing each image Pj, from one or several error margins of the initial segmentation of the image I so as to obtain a corresponding image Uj; (S4) processing the pixels/voxels of the 2D/3D image I corresponding to the uncertain area of the image Uj; (S5) determining an image Ej of discrepancy between the pixels/voxels Fjn of the mask Fj and the pixels/voxels Pjn of the image Pj; (S7) performing an assignment processing of each pixel/voxel Ejn with discrepancy to assign it or not to the object Aj and thus obtain a final segmentation mask Mj including a refined segmentation of the object Aj.

### FIELD OF THE INVENTION

The invention concerns a method for segmenting a 2D or 3D image, for example of a subject, a patient or a structure. In particular, the 2D or 3D image contains an object to be segmented, for example a bone.

### STATE OF THE ART

The segmentation of an image consists of classifying each pixel or voxel of an image (2D or 3D) as belonging or not to an object, for example a bone.

Regardless of the application, a precise segmentation is desirable, and accurate segmentation should generally follow the most visible contour in the image.

For example, in orthopedic surgery, the bone segmentation in images can be performed manually by an annotator, using interactive annotation and image processing tools, and/or automatically by segmentation algorithms.

However, the manual methods are inherently prone to human bias and are not very precise, while semi-manual methods are complex and time-consuming. With automatic methods, the gains in convenience and speed or precision are offset by lower robustness. These methods are therefore not satisfactory for obtaining precise and accurate object segmentation, for example in computed tomography (CT) or cone beam computed tomography (CBCT) images.

### DISCLOSURE OF THE INVENTION

The invention proposes to segment in a precise and accurate manner one or several object(s) contained in an image, preferably medical.

To this end, the invention proposes a computer-implemented method for segmenting an image, comprising
Obtaining a 2D/3D image I of a region of interest of an element comprising at least one object Aj, j=1 to J, the 2D/3D image I comprising N pixels/voxels In, n=1 to N;
Performing an initial segmentation of the 2D/3D image I so as to obtain J image Pj of segmented object Aj, each image Pj comprising N pixels/voxels Pjn of which each center is a probability of belonging to the object Aj;
Processing each image Pj, from one or several error margins of the initial segmentation of the image I so as to obtain a corresponding image Uj, the image Uj comprising a first area and a second area, the first area comprising only pixels/voxels Ujn which reliably belong to the object, the first area being totally included in the object Aj; the second area comprising only pixels/voxels Ujn which reliably do not belong to the object Aj; the pixels/voxels belonging neither to the first area nor to the second belonging to an area called «uncertain area»;
Processing the pixels/voxels of the 2D/3D image I corresponding to the uncertain area of the image Uj such that the values of the pixels/voxels corresponding to the uncertain area of the image Uj are defined relative to a boundary delimiting the object Aj in the 2D/3D image I in the uncertain area, the boundary being the most visible one in the uncertain area, the pixels/voxels processed in the uncertain area and the pixels/voxels of the first and second areas defining a mask Fj;
Determining a discrepancy image Ej between the pixels/voxels Fjn of the mask Fj and the pixels/voxels Pjn of the image Pj, the non-zero pixels/voxels Ejn of the discrepancy image Ej being pixels/voxels in discrepancies, these pixels/voxels being grouped into M disjoint groups EGjm called «discrepancy», a discrepancy EGjm being a set of pixels/voxels in discrepancy Ejn having the same value different from zero, the discrepancy EGjm and therefore the pixels/voxels in discrepancy Ejn of the discrepancy EGjm being classified as «significant» if the size and/or depth of the set is greater than a threshold E_{MIN} and/or E_{DEPTH} and «not significant» otherwise;
Performing an assignment processing of each pixel/voxel Ejn in discrepancy to assign it or not to the object Aj and thus obtain a final segmentation mask Mj comprising a refined segmentation of the object Aj, the assignment processing comprising an assignment rule defined in the following manner, for each pixel/voxel n of each significant discrepancy EGjm, if Ejn=1 then Mjn=0, the pixel/voxel Ejn not belonging to the object Aj, if Ejn=−1 then Mjn=1, the pixel/voxel Ejn belonging to the object Aj, the remaining pixels Mjn being identical to the corresponding pixels Fjn of the mask Fj.

The invention is advantageously supplemented by the following features, taken alone or in any of their technically possible combinations:
the assignment processing comprises an assignment rule defined as follows:

| Value of the pixel | Class(es) | Value of the |
|---|---|---|
| Ejn of EGjm | of EGjm | pixel Mjn |
| 1 (in FBj, out of PBj) | S (Significant) | 0 |
| −1 (out of FBj, in PBj) | S (Significant) | 1 |

Mjn=1 when the pixel/voxel with significant discrepancy Ejn belongs to the object Aj and Mjn=0 when the pixel/voxel with significant discrepancy Ejn does not belong to the object Aj, the other remaining pixels/voxels Mjn being identical to the corresponding pixels Fjn of the mask Fj.
the method comprises a step of classifying each pixel/voxel n of each significant discrepancy EGjm (class S) according to one of the following classes: Inside the object Aj (IN) or outside the object Aj (OUT) using a previously trained classification model.
the classification takes into account at least one subclass allocated to each significant discrepancy, this subclass being used depending on the use case of the final segmentation Mj to discriminate discrepancies that can be assigned to one or other of the classes depending on the use case.
the assignment rule is further defined as follows

| Value of the pixel | Class(es) | Value of the |
|---|---|---|
| Ejn of EGjm | of EGjm | pixel Mjn |
| 1 (in FBj, out of PBj) | S and IN (Inside Aj) | Fjn (>0.5) |
| −1 (out of FBj, in PBj) | S and IN (Inside Aj) | 1 |
| 1 (in FBj, out of PBj) | S and OUT (Outside Aj) | 0 |
| −1 (out of FBj, in PBj) | S and OUT (Outside Aj) | Fjn (≤0.5) or 0 |

Mjn=1 or >0.5 when the pixel/voxel in discrepancy Ejn belongs to the object Aj and Mjn=0 or ≤0.5 when the pixel/voxel in discrepancy Ejn does not belong to the object Aj, the other remaining pixels/voxels Mjn being identical to the corresponding pixels Fjn of the mask Fj.
the processing of each image Pj to obtain the image Uj (S3) consists, for all pixels/voxels n from 1 to N:
if P_{IN j,n}>P_{HIGH j}, where P_{IN j,n} is the minimum value of the points of the image Pj in a convolution kernel K_{IN j} around the pixel/voxel Pjn of Pj, the pixel/voxel Ujn of the image Uj belongs to the first area;
if P_{OUT j,n}<P_{Low j} where P_{OUT j,n} is the minimum value of the points of the image Pj in a convolution kernel K_{OUT j} around the pixel/voxel Pjn of Pj or if P_{IN k,n}>P_{HIGH k} for k=1 to J where k≠j, the pixel/voxel Ujn of the image Uj belongs to the second area.
P_{HIGH j}=½, P_{LOW j}=½ and in which the pixels/voxels of the first area have a probability equal to 1, the pixels/voxels of the second area have a probability equal to 0, the pixels/voxels of the uncertain area have a probability equal to ½.
the most visible boundary is obtained by processing the 2D/3D image I in the uncertain area using a graph cut algorithm, the most visible boundary Fj being the minimum cut of a graph connecting the neighboring pixels/voxels in the uncertain area by links having a capacity defined by a function ƒ of the image I and possibly of the initial segmentation Pj, the minimum cut being obtained by means of an algorithm configured to solve a maximum flow problem.
the most visible boundary, is obtained by processing the 2D/3D image I in the uncertain area to obtain a geodesic curve/surface, the geodesic curve/surface being characterized by a function fusing the magnitude of the gradient of the image I, the most visible boundary being the one which is the solution to the dual problem of the combinatorial continuous max flow (CCMF) algorithm, solved for example by the Primal-dual interior point (PDIP) algorithm, or an algorithm for solving partial differential equations of the continuous max flow problem of the Appleton-Talbot Continuous Max Flow (AT-CMF) type.
the function ƒ uses the magnitude of the gradient of the image I and possibly the magnitude of the gradient of the initial segmentation Pj to discriminate an external boundary of Aj from internal boundary(s) of Aj, for example by using the scalar product of the normalized gradient vectors of Pjn and In, for example with 0<a<1:

$$f ( In , Pjn ) = ‖ \vec{∇} In ‖ \cdot max ( α ; 1 / 2 ( 1 + cos ( \vec{∇} In , \vec{∇} Pjn ) ) ) .$$

the determination of the image Ej (S5) comprises a binarization of the mask Fj and the image Pj consisting of obtaining a binary image FBj in which each pixel FBjn is equal to 1 if Fjn>0.5 otherwise 0 and a binary image PBj in which each pixel PBjn is equal to 1 if Pjn>0.5 otherwise 0, the binary mask FBj and the binary image PBj being binary versions of the mask Fj and the image Pj where a pixel/voxel of the binary mask FBj and/or of the binary image PBj is equal to 1 for each pixel/voxel greater than 0.5 or 0 for each pixel/voxel less than 0.5, the image Ej comprising pixels/voxels whose levels are 0, +1 or −1, the uncertain pixels/voxels having a value equal to −1 or +1, the discrepancy image Ej being determined from the binary images FBj and PBj.
the discrepancy image Ej includes pixels/voxels Ejn=1 if the pixel In of the image I is included in the binary mask FBj and outside the binary image PBj, Ejn=0 if the pixel In of the image I is included in the mask FBj and in the mask PBj or outside the mask FBj and the mask PBj, Ejn=−1 if the pixel In of the image I is outside the binary mask FBj and included in the image PBj.
the method comprises a step of determining a curve/surface Cj delimiting the object Aj in the final segmentation mask Mj, the curve/surface Cj corresponding to a boundary in the final segmentation mask Mj obtained by means of a SurfaceNets, Marching Squares/Cubes, Cubical Marching Squares or Flying Edges algorithm.
the image I is a 3D image reconstructed from a number K of 2D images from which the projection parameters are obtained, for example K between 1 and 10, and the boundary Fj is then determined on an image which is a linear combination of I and the K 2D images back-projected into the space of I according to their respective projection parameters, for example a weighted average where I has a weight equal to K and the K images each have a weight of 1.

### DESCRIPTION OF FIGURES

Other features, aims and advantages of the invention will emerge from the following description, which is purely illustrative and non-limiting, and which must be read in conjunction with the appended drawings in which:

FIG. 1 illustrates steps of a segmentation method according to one embodiment of the invention.

FIG. 2 illustrates an initial 2D image I of a region of interest comprising three objects A1, A2, A3, the image I comprising N pixels In, n=1 to N.

FIG. 3 illustrates an initial segmentation of the 2D image I so as to obtain J images Pj of segmented object Aj, each image Pj comprising N pixels Pjn each value of which is a probability of belonging to the object Aj.

FIG. 4 illustrates a processing of each image Pj, from one or several margins of error of the initial segmentation of the image I for an image comprising a first area Z1 and a second area Z2, the first area Z1 comprising only pixels which reliably belong to the object, the first area Z1 being totally included in the object; the second area Z2 comprising only pixels which reliably do not belong to the object; the pixels belonging neither to the first area nor to the second belonging to an area Z3 called “uncertain area”.

FIG. 5 illustrates a processing of the pixels of the initial 2D image I corresponding to the uncertain area of the image in such a way that the values of the pixels corresponding to the uncertain area of the image Uj are defined relative to the most visible boundary delimiting the object Aj in the 2D/3D image I in the uncertain area, the pixels processed in the uncertain area and the pixels of the first and second areas defining a mask Fj of the most visible boundary and a mask Vj of the relative visibility of this boundary in each pixel/voxel.

FIG. 6 illustrates a determination of a discrepancy image Ej between the pixels Fin of the mask Fj and the pixels Pjn of the image Pj.

FIG. 7 illustrates the processing of significant discrepancies in class(es) or even sub-class(es).

FIG. 8 illustrates a processing of assignment of each pixel in discrepancy to assign it or not to the object Aj and thus obtain a final segmentation mask Mj comprising a refined segmentation of the object Aj.

In all figures, similar elements relate to similar elements.

### DETAILED DESCRIPTION OF THE INVENTION

### General Presentation of the Method

The method according to the invention comprises the main steps below making it possible to obtain a segmentation of objects in 2D or 3D images precise to within one pixel/voxel, or even less, and following the objectively most visible boundary in the initial image if and only if it is determined to be precisely that of the object:
Step S1: Obtaining an initial 2D or 3D image I;
Step S2: Obtaining an initial segmentation of one or several objects, for example semi-automatically or with a model trained by machine learning;
Step S3: Automatically determining an uncertain area relative to each segmented object, for example according to errors in distance and/or probability characteristic of the initial segmentation and determined beforehand;
For each segmented object the steps are implemented.
Step S4: Determining a segmentation, following the most visible boundary in the image I separating the object from the rest of the image in the uncertain area;
Step S5: Determining and locating groups of related pixels/voxels in discrepancy between the initial segmentation (S2) and the most visible boundary (S4), these discrepancies being located in the uncertain area (S3), each discrepancy being classified according to its dimensions as «significant» or «non-significant»;
Step S6 (optional): Classifying each significant discrepancy according to other features that may be a function of the initial image I;
Step S7: Deciding to include or exclude each discrepancy of the object based on this or these classifications;
Step S8 (optional): Obtaining a curve/surface following a contour of the segmented object in sub-pixel/voxel precision.
   Initial image I (step S1)

The method comprises a step S1 of obtaining an initial 2D or 3D image denoted I of a region of interest comprising J object(s) Aj, j=1 to J. An object is preferably bone, cartilage or ligament. Nonetheless, the method described here is applied to any type of object with contours visible in the image I. This image I is acquired by means of an imaging system of known type depending on the type of initial desired image and will not be described further.

The initial image I partitions the 2D or 3D physical space where the objects Aj are located into pixels or voxels indicating for each one or several real number(s), this number(s) being influenced by the nature and proportion of the objects Aj present in each pixel or voxel, for example, the absorption of X-rays, the relaxation of the spin of atoms, the reverberation of a wave, etc. depending on the selected acquisition modality. The initial image I is for example an image of X-ray fluorography, MRI, CT or CBCT.

Additionally, in the case of a 3D image, the initial 3D image I can be reconstructed from a small number of lower-dimensional images:
a reconstructed 3D image with a reduced number of ultrasound slices or;
a 3D X-ray absorption image reconstructed with a reduced number of 2D radiographs.

For example, the number K of images is comprised between 1 and 10.

This initial image I therefore comprises N pixels/voxels denoted In=uₙ with n=1 to N, Uₙ being the value of the pixel/voxel.

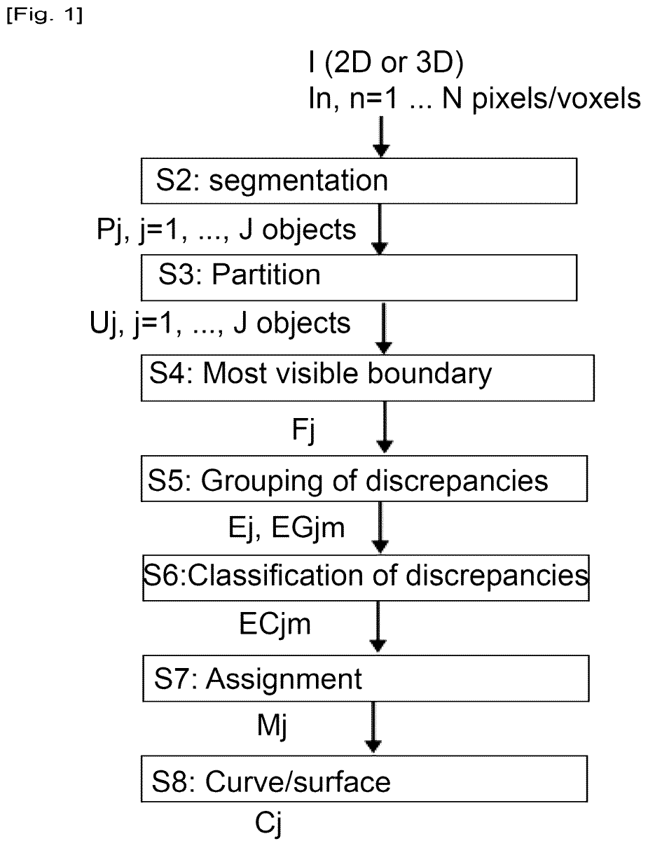

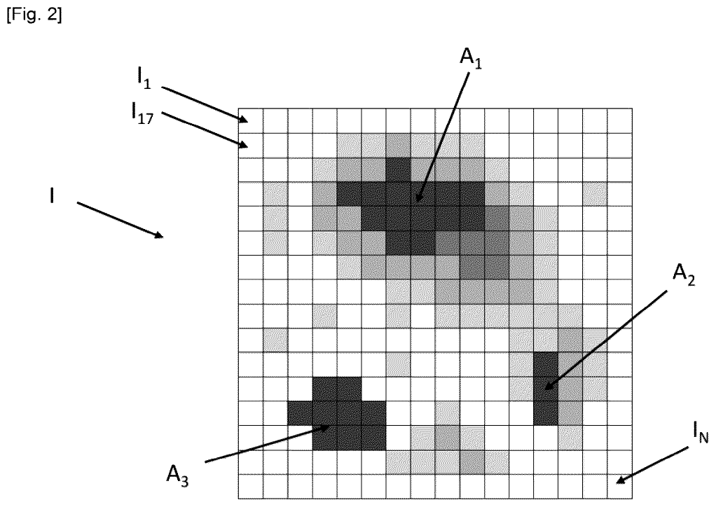

FIG. 2 illustrates a 2D image I of N=16×16=256 pixels whose values are influenced mainly by the nature and proportion of each object in each voxel, for example Iₙ∈[0, 255] for all n∈[1, N]. The proportion is visible in FIG. 1 in relation to the gray level. The darker the pixel, the more the object Aj is present in proportion. Conversely, the lighter the pixel, the less the object Aj is present in proportion. When an object fully occupies a pixel/voxel, the value of the pixel/voxel depends only on the nature of this object and the selected imaging system.

### Initial Segmentation Pj of an Object (Step S2)

In a step S2, the initial image I is processed according to at least one initial segmentation so as to obtain, for each initial segmentation, J image(s) Pj of segmented object Aj. At the end of this or these initial segmentation(s), we obtain J*S image(s) Pj each comprising N pixels/voxels of which each value is a probability of belonging to the object Aj, Pj,s denoting the image Pj corresponding to a segmentation s carried out, S being the number of different segmentations carried out, and s=1 to S. The set of images Pj of segmented object Aj is called the first set.

This initial segmentation can indeed be implemented in several ways and must be robust, that is to say, it must avoid large errors. Nonetheless, its precision is limited. Such an initial segmentation thus presents one or several margins of error characteristic of the initial segmentation method in pixel(s)/voxel(s) value (i.e. in number of pixel(s)/voxel(s), possibly with decimals) and/or in distance, for example a method presents maximum errors in distance of ±2 pixels/voxels, or maximum errors in probability of ±0.1, or a combination of the two makes it possible to better characterize the maximum errors and to obtain uncertain areas that are smaller on average in the step S3.

The initial segmentation can be implemented manually, semi-automatically or by means of a neural network trained for image segmentation.

Carrying out several initial segmentations also allows you to test several algorithms, different parameters, etc., and to further improve the quality of the result as will be seen later.

Alternatively or in a complementary manner, each initial segmentation can combine several types of segmentations, for example by averaging the annotations of several methods or annotators, possibly weighted by their performance.

The annotations can be incomplete or even only point-based and the segmentation obtained by considering for each pixel/voxel In, is for example a probability of belonging to the object of the nearest annotated point, possibly based on the distance.

The initial segmentation can be binary and made non-binary by applying, for example, a convolution operation such as a Gaussian blur.

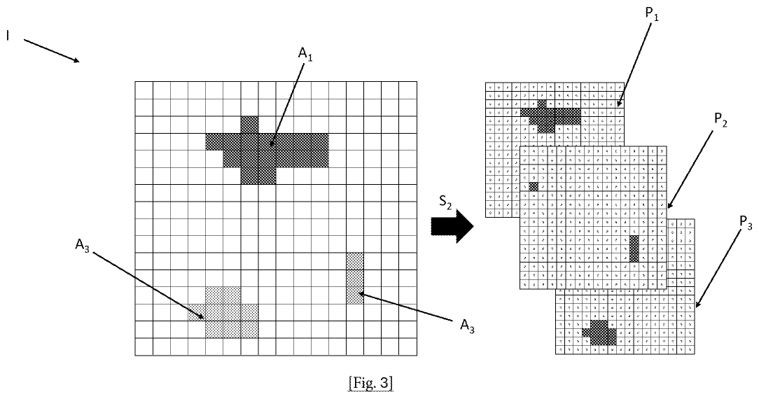

FIG. 3 illustrates an example of an initial segmentation: on the left the initial image I comprising three segmented objects A1, A2, A3 and on the right the different resulting images Pj P1, P2, P3 comprising pixels/voxels at 1 or 0 depending on whether they belong to the object Aj or not.

Partition Uj of the Initial Segmentation Pj into 3 Areas, One of which is Uncertain (Step S3)

During a step S3, each image Pj is processed, based on one or several error margins of the initial segmentation of the image I so as to obtain at least one corresponding image Uj comprising N pixels/voxels.

It is understood that each image Pj of the first set (i.e. obtained for each segmentation) is processed.

Thus again, in the case of a plurality of initial segmentations, the step S3 is advantageously repeated for each segmentation, so as to process each image Pj,s, from one or several margins of error of the s-th initial segmentation of the image I so as to obtain one or several corresponding image(s) Uj,s comprising N pixels/voxels and corresponding to an image Pj,s. The set of obtained images Uj is called the second set.

The objective of this step S3 is to partition each image Pj by defining the following areas taking into account one or several possible error(s) of the initial segmentation:
A first area comprising only pixels/voxels Ujn of Uj which reliably belong to the object Aj;
A second area comprising only pixels/voxels Ujn of Uj which reliably do not belong to the object Aj;
An uncertain area comprising pixels/voxels that belong neither to the first nor to the second area.

The pixel/voxel values of the first area are preferably set to 1, those of the second area set to 0 and those of the uncertain area set to ½.

According to one embodiment, to partition the image Pj automatically, the procedure is as follows:
For all n in [1 . . . N]:
   Ujn=1 if:

$${P}_{IN jn} > {P}_{HIGH j} ( typically > 1 / 2 )$$

where P_{IN jn} is the minimum value of the points of Pj in a convolution kernel K_{IN j} around Pjn
Ujn=0 if:

$${P}_{OUT jn} < {P}_{LOW j} ( typically < 1 / 2 )$$

where P_{OUT jn} is the maximum value of the points of Pj in a convolution kernel K_{OUT j} around Pjn

$${P}_{IN kn} > {P}_{HIGH k}$$

for all k in [1 . . . J] where k≠j
where P_{IN kn} is the minimum value of the points of Pk in a convolution kernel K_{IN k} around Pkn
Otherwise Ujn=½.

In other words, the partition Uj of Pj comprises a first area totally included in the object Aj (erosion) and the second area is an area which is beyond the object (dilation).

We therefore obtain the image Uj where the pixels Ujn for all n in [1 . . . N] have a probability among {1, ½, 0} for each voxel center In of belonging to Aj knowing the characteristic errors of the initial segmentation and the other segmented objects. Note that these characteristic errors are determined before the initial segmentation of image I by a characterization of the errors of the initial segmentation method.

Alternatively, the uncertain area can also be obtained by simple thresholding operations and/or discrete mathematical morphology, i.e. in the domain {0,1} or even manually.

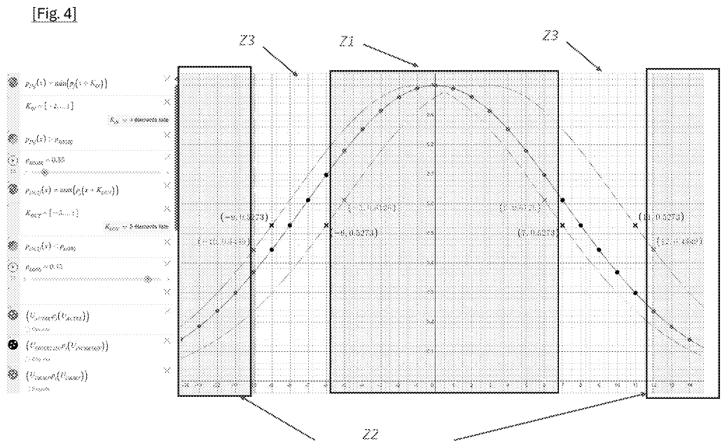

FIG. 4 illustrates the step S3 by considering the probability of 1D points belonging to an object around x=0 following a Gaussian, the step S3 allows to partition the points according to different neighborhoods inside (first area Z1) and outside (second area Z2), and even according to different directions of the 1D image (K_{IN} and K_{OUT} are anisotropic), as well as according to different probability thresholds to determine an uncertain area taking into account at best a large number of possible characteristic errors for the initial segmentation method. The uncertain area Z3 is the complementary area of the first and second areas Z1, Z2.

According to one embodiment and to allow the following step to determine the most visible boundary of the object in an uncertain area which completely separates the first and second areas Z1, Z2, it is preferable to choose convolution kernels K_{IN x}. K_{OUT x} of size strictly greater than 1 pixel in all dimensions of I and a threshold P_{LOW x}≤P_{HIGH x}.

In a complementary manner, it is possible to treat the non-connected components of Z1, Z2 in the image Uj by integrating them into the uncertain area to let the next step determine whether or not there is a boundary connecting them in the image I.

And in all cases, for each image Pj of the first set, one can optionally obtain several corresponding images Uj by implementing the step S3 several times, in particular by varying the processing parameters of the step, called uncertain area parameters, such as the error margins or even the thresholds (in particular P_{HIGH j} and P_{LOW j}), so as to obtain larger or smaller uncertain areas. Thus, the second set can comprise more than J*S images Uj.

It is furthermore entirely possible to obtain a variable number of Uj images for each initial segmentation, some segmentations allowing or requiring more than others the variability of said uncertain area parameters.

Mathematically, by denoting nₛ the number of images Uj,s obtained for the image Pj,s (i.e. for the s-th segmentation) at the step S3 (with nₛ≥1), we set for convenience

$${S}^{′} = {\sum }_{s = 1}^{S} {n}_{s} \geq S$$

the total number of images Uj for each object Aj, and therefore the step S3 sees the obtaining of J*S′ images Uj (in the second set).

### Most Visible Boundary Fj in the Uncertain Area of Uj (Step S4)

In a step S4, the uncertain area determined in step S3 is used to, in the initial image I, detect the most visible boundary in this uncertain area. The most visible boundary separates in the uncertain area the pixels/voxels belonging to the object Aj from the others.

In particular, the pixels/voxels corresponding to those of the uncertain area identified in the image Uj are associated with a function ƒ measuring the visibility of the boundary of the object between neighboring pixels/voxels by considering the intensities of the pixels/voxels in the image I and possibly the initial segmentation Pj. This function is used to determine the boundary which is globally the most visible, that is to say the one which globally optimizes this function. This boundary is expressed in the form of a segmentation mask denoted Fj.

It is understood that each image Uj of the second set (i.e. obtained for each initial segmentation and/or each different case of uncertain area parameters) is processed.

Thus once again, in the case of a plurality of images Uj, the step S4 is advantageously repeated so as to proceed each image Uj,s so as to obtain a corresponding mask Fj,s. The set of obtained masks Fj is called the third set.

According to one embodiment, a graph cut algorithm is used, the most visible boundary being the minimal cut of a discrete graph connecting neighboring pixels/voxels in the uncertain area by links having a maximum capacity defined by the function ƒ, the minimal cut being obtained by means of an algorithm for solving the dual problem of maximum flow passing through the links of the graph (Graph Cut, GC). In this respect, reference may be made to the document Krčah Marcel, Gábor Székely, and Remi Blanc. “Fully automatic and fast segmentation of the femur bone from 3D-CT images with no shape prior.” 2011 IEEE international symposium on biomedical imaging: from nano to macro. IEEE, 2011.

According to one embodiment, a method for approximating a continuous geodesic curve/surface is used, the geodesic curve/surface being characterized by a metric, the metric being an anti-monotonic function of the function ƒ, the most visible boundary being the approximate solution of this geodesic curve/surface, the approximate solution being obtained by means of a known algorithm for solving the dual problem of continuous max flow (CMF), for example the Primal-Dual Interior Point (PDIP) algorithm for solving the combinatorial formulation of the problem (CCMF), or a partial differential equation solving algorithm for solving a physical formulation of the problem, for example Appleton-Talbot Continuous Max Flow (AT-CMF). For these algorithms, reference may be made to the following documents:
Couprie, Camille & Grady, Leo & Talbot, Hugues & Najman, Laurent. (2010). Combinatorial Continuous Maximal Flows. CoRR. abs/1010.2733;
Appleton, Ben & Talbot, Hughes. (2003). Globally Optimal Surfaces By Continuous Maximal Flows.

Determining the most visible boundary implements one or several functions ƒ (In, Pjn) increasing when the boundary of Aj is more visible in the image I. To bring the most precision to the final segmentation, the function ƒ (In, Pjn) must take into account the most local possible features, that is to say for each In, take into account only the values of In and/or its neighbors in the image I, for example, a norm of a discretized gradient of the image I not introducing an offset, for example the central difference of In. When the image I comprises several values like a color image or more generally a multispectral image, the visibility of the boundary can depend on one or several of these values.

In a complementary manner, it may be useful to discriminate internal or external boundaries of the object Aj. To do this, a directional component is introduced into the metric to ensure that, for example, the outer boundary of the cortical bone (decreasing intensities from the inside to the outside) is segmented instead of its inner boundary (increasing intensities from the inside to the outside).

In this case, the function ƒ uses the gradient vector of the image I and the gradient vector of the initial segmentation Pj to discriminate an external boundary of Aj from internal boundary (boundaries) within Aj, for example using the scalar product of the normalized gradient vectors of Pjn and In, for example with 0<a<1:

$$f ( In , Pjn ) = ‖ \vec{∇} In ‖ \cdot max ( α ; 1 / 2 ( 1 + cos ( \vec{∇} In , \vec{∇} Pjn ) ) ) .$$

Such a function ƒ is expressed as a function of I and Pj, to be higher on the pixels/voxels where the gradient vector of Pjn is in a direction opposite to the gradient vector of In, thus making these pixels/voxels less “sharp” than the pixels with a similarly high gradient of In but oriented differently.

At the end of this step S4, for each image Uj of the second set, a mask Fj is obtained which comprises the pixels/voxels of the first area and second area and, in the uncertain area, the values adjusted with respect to the most visible boundary.

In a complementary manner, when the PDIP algorithm is used to obtain the most visible boundary, it provides at each iteration a solution v (nu) surrounding the most visible sought boundary and generally converging quickly towards it. The PDIP algorithm also provides a variable λ (lambda) quantifying the relative contribution of each pixel/voxel to the visibility of the sought boundary.

In this case, at the end of step S4, Vj=λ a local visibility indicator of the boundary Fj strictly positive and increasing with the local visibility of the boundary at the level of In is obtained, Vj being able to be advantageously normalized between 0 and 1.

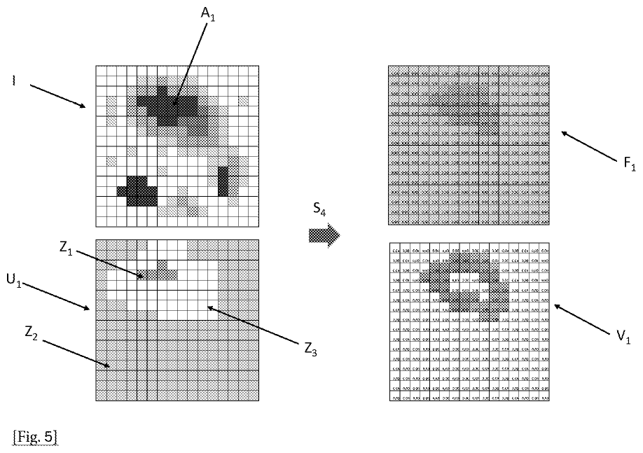

FIG. 5 illustrates in 2D the image I with the object A1 in particular, the corresponding image U₁, the resulting mask F₁ as well as the local visibility indicator V₁. The mask F₁ is obtained by approximation of a geodesic, the pixels of F₁ corresponding to the uncertain area Z₃ of U₁ then receiving a value close to 0 (out of A₁) or 1 (in A₁) except the pixels on either side of the most visible boundary in the image I which receive a value on either side of ½. The threshold of ½ makes it possible to segment the pixels on either side of this boundary. The mask V₁ is obtained by the PDIP algorithm, the pixels having a value close to 0 except the pixels on either side of the most visible boundary in the image I which receive a value all the greater as the boundary is locally more visible.

It can be observed that from the image I and the image U₁, in the uncertain area Z₃, the mask F₁ segments the pixels on either side of the most visible boundary in the initial image I.

### Discrepancy Image, Grouping and Classification by Dimension (Step S5)

In a step S5, at least one discrepancy image Ej between the pixels/voxels Fjn of a mask Fj and the pixels/voxels Pjn of the image Pj is determined, the non-zero pixels/voxels Ejn of the discrepancy image Ej being pixels/voxels with discrepancies. It is understood that at the end of step S4, for each object Aj, at least one mask Fj has been obtained, and advantageously a plurality of masks Fj corresponding to several initial segmentations and/or various uncertain area parameters.

In the case where there is only a single mask Fj for each object Aj (i.e. the third set contains J masks Fj) one can of course only calculate the discrepancy between the pixels/voxels Fin of the mask Fj and the pixels/voxels Pjn of the image Pj, i.e. determine a discrepancy image Ej for each object Aj.

If there is at least two masks Fj per object Aj (for example if two different initial segmentations were made in step S2), one can repeat step S5, and for each mask Fj of the third set, determine a discrepancy image Ej between the pixels/voxels Fjn of the mask Fj and the pixels/voxels Pjn of the image Pj (i.e. up to J*S′ discrepancy images Ej), so as to exploit the performance of each segmentation/parameterization.

It is particularly interesting to have several masks Fj corresponding to several initial segmentations and/or various uncertain area parameters, which makes it possible to be sure of detecting any segmentation error even if it is made both by the initial segmentation and by the search, in different uncertain areas, for the most visible boundary (boundaries) in the image.

The idea here is to compare the pixels/voxels of the mask(s) Fj with those of the image Pj to determine the discrepancies which should be classified as belonging or not belonging to the object Aj.

Preferably, this discrepancy image Ej is obtained from binary versions of the mask(s) Fj and of the image Pj.

To do this, the binary version FBj of Fj and the binary version PBj of Pj are obtained according to the following rule:

For all n in [1, . . . , N]:
FBjn=1 if Fjn>0.5 otherwise 0;
PBjn=1 if Pjn>0.5 otherwise 0.

Then each discrepancy image between the initial segmentation and the most visible boundary of Aj in the uncertain area Ej=FBj−PBj is determined where
Ejn=1 if In is in FBj (=1) but out of PBj (=0)
Ejn=0 if In is in FBj (=1) and PBj (=1), or out of FBj (=0) and PBj (=0)
Ejn=−1 if In is out of FBj (=0) but in PBj (=1)

Then, by a known connected component analysis, the set EGj of the coordinates, and optionally of other features such as bounding boxes, of the M disjoint groups of related pixels/voxels EGjm with value 1 and −1 called discrepancies is obtained, the discrepancy EGjm being classified as “significant” (class S) if the size and/or depth of the set of these pixels/voxels is greater than a threshold E_{MIN} and/or E_{DEPTH} and “not significant” (class NS) otherwise.

The pixels/voxels of the non-significant discrepancies (class NS) will be assigned in step (S7) so as to follow the most visible boundary to correct the lack of precision of the initial segmentation.

It is noted that the number of obtained discrepancy images Ej can be quite high, up to J*S′, that is to say the maximum number of discrepancies between the pixels/voxels Fjn of a mask Fj and the pixels/voxels Pjn of the image Pj.

If there is more than one obtained discrepancy image Ej for an object Aj, one can proceed in various ways, and preferentially combine these discrepancy images Ej into a global discrepancy image noted Ej, in particular by a majority system: for a pixel/voxel n one count the number of times that Ejn=1 and the number of times that Ejn=0, and EΣjn=the majority value. Alternatively, one could, for example, take an average and binarize again, or use any known technique.

Then, one can group the non-zero pixels/voxels EΣjn of the global discrepancy image EΣj into discrepancies noted EΣGjm, classify them as significant or not and continue the method on the basis of the global discrepancy image EΣj and its discrepancies EΣGjm as if it were the only discrepancy image Ej.

Alternatively, one can still determine the discrepancies EGjm for each discrepancy image Ej independently, and directly combine these discrepancies into EΣGjm, again by majority or otherwise, for example by identifying the “groups” of discrepancies corresponding in practice to the same region of interest as sharing a common non-empty intersection.

Alternatively again, one can keep the plurality of discrepancy images Ej and all the discrepancies EGjm, see below.

### Optional Classification of Significant Discrepancies (Step S6)

When the discrepancies are significant (class S), it may be advantageous to interpret them to determine whether the most visible boundary is that of the object Aj and further assign them to one of the following classes: Inside the object Aj (class IN) or outside the object Aj (class OUT).

Such an interpretation is implemented by means of a classification model, for example, a neural network, trained by deep learning, taking as input a region of interest of I centered on the coordinates or on the bounding box of a significant discrepancy (class S) EGjm, and the same region of interest of Ej. In case of a plurality of discrepancy images Ej, said model can take as input either a global significant discrepancy (after combination) EΣGjm, or a vector of the significant discrepancies EGjm of non-empty common intersection.

In all cases, the classification performed for a discrepancy EGjm/EΣGjm can be assigned at step (S7) to all the pixels/voxels of said considered discrepancy, or just a potentially very small subset of its pixels/voxels and located at the center of said discrepancy, for example the smallest non-empty set of pixels/voxels after at least one erosion step in at least one dimension of the image. This cleverly avoids small segmentation artifacts at the boundary between 2 discrepancies EGjm classified differently.

Furthermore, it may be useful for surgery planning to allocate a subclass that can explain the segmentation discrepancy or influence the surgery, for example for a bone-type object Aj in a CT image:
belonging to a neighboring bone (for example, ribs, ossicles, etc.) or a bony outgrowth not relevant to surgery (for example, an osteophyte, etc.);
an artifact causing values possibly lower than the lower bone limit of 700 HU (for example, shadowing, beam hardening, ring artifacts, etc.);
a condition explaining local under-intensity (for example osteoporosis, tumor, geode, etc.);
an artifact causing values possibly higher than the higher bone limit of 3000 HU (for example, streak, ring artifacts, etc.);
calcification of other neighboring tissue (for example, ligament, artery, etc.);
the presence of equipment (e.g. pedicle screw, etc.);
Certain subclasses such as “geode” or “belonging to a neighboring bone” can in themselves justify assigning a discrepancy to one of the classes IN or OUT.

In a complementary manner, to assign a significant discrepancy (class S) to one of the classes IN or OUT, it may be useful to also consider the use case. For example, the “osteophyte” subclass may be allocated to the class OUT for a final segmentation intended to calculate the size of an implant, but to the class IN for a final segmentation intended to determine the area of bone that a robot must cut.

Thus, depending on the subclass and optionally the use case, the discrepancy can be integrated in the most accurate way into the class IN or OUT.

At the end of this step S6 one obtains ECjm the set of class(es) and possibly subclass(es).

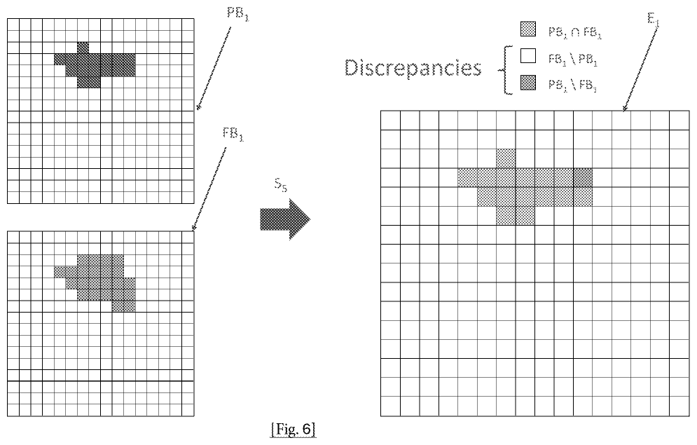

FIG. 6 illustrates in 2D a binarized segmentation PB₁ and a binarized boundary FB₁ whose difference reveals the discrepancy image E₁ in three connected components EGjm, one of which is not significant in size (comprising a single pixel).

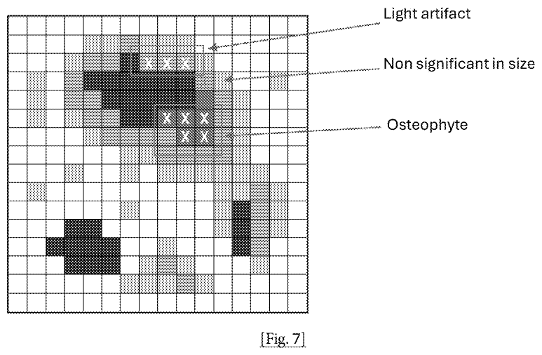

FIG. 7 illustrates in 2D an image I comprising two significant discrepancies classified by a classification model. The significant discrepancies are those corresponding to a light artifact and an osteophyte. The latter must be classified as belonging to the object or not afterwards.

Assignment of Each Pixel/Voxel with Discrepancy Ein (Step S7)

In a step S7 each pixel/voxel with discrepancy Ejn (see steps S5 and S6) is then assigned to the final segmentation mask Mj comprising a refined segmentation of the object Aj.

More precisely, it involves processing each pixel/voxel n of each significant discrepancy EGjm of at least one discrepancy image Ej (including the possible global discrepancy image EΣj), to assign it or not to the object Aj and thus obtain a final segmentation mask Mj comprising a refined segmentation of the object Aj (also called final segmentation, as opposed to the initial segmentation(s)).

If there is a single discrepancy image Ej, this one is used. If there are several discrepancy images Ej, one can either use a global discrepancy image EΣj as mentioned before (and therefore process each pixel/voxel n of each significant global discrepancy EΣGjm of the global discrepancy image EΣj, to assign it or not to the object Aj), or again use all the discrepancies EGjm of the various Ej.

There shall be no limitation as to how the final segmentation mask Mj is obtained from the discrepancy image(s) Ej.

According to a first embodiment, the assignment is implemented according to the assignment rule defined in the following manner, for each pixel/voxel n of each significant discrepancy EGjm (class S) of at least a given number of discrepancy images Ej (for example at least 80% of the discrepancy images) or of a combination of the discrepancy images Ej (the global discrepancy image EΣj), if Ejn=1 then Mjn=0, the pixel/voxel Ejn not belonging to the object Aj, if Ejn=−1 then Mjn=1, the pixel/voxel Ejnp belonging to the object Aj, the remaining pixels Mjn being identical to the corresponding pixels Fin of the mask Fj to precisely follow the most visible boundary in the absence of discrepancy or when the discrepancies are not significant (class NS).

According to a second embodiment, the pixels/voxels with significant discrepancies (class S) are assigned more finely taking into account their class determined in step S6 (classes IN or OUT).

The two embodiments can be summarized as follows: Mj=Fj, then for each discrepancy EGjm of EGj and for each pixel/voxel n of EGjm located in Ej, Fj, Pj and Mj, the assignment is implemented as follows.

| Value of the pixel/voxel | Class(es) | Value of the |
|---|---|---|
| Ejn of EGjm | of EGjm | pixel/voxel Mjn |
| 1 (in FBj, out of PBj) | S (Significant) | 0 |
| −1 (out of FBj, in PBj) | S (Significant) | 1 |
| 1 (in FBj, out of PBj) | S and IN (Inside Aj) | Fjn (>0.5) |
| −1 (out of FBj, in PBj) | S and IN (Inside Aj) | 1 |
| 1 (in FBj, out of PBj) | S and OUT (outside Aj) | 0 |
| −1 (out of FBj, in PBj) | S and OUT (outside Aj) | Fjn (≤0.5) or 0 |

Thus, according to a first embodiment (only the first two lines of the table above), the pixels/voxels Ejn with discrepancy are assigned or not to the mask Mj according to their class NS or S and their value +1, −1 only.

According to a second embodiment, when the pixel/voxel with discrepancy Ejn is significant (class S) then it is interpreted by a classification model which can take into account the initial image and the use case and its resulting class IN or OUT is taken into account, those which are not significant (class NS) being classified only in relation to their value as in the first embodiment.

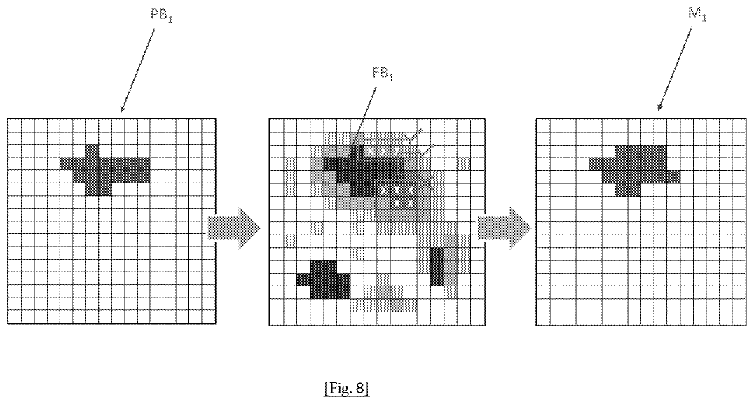

FIG. 8 illustrates in 2D an initial segmentation PB₁ towards the most visible boundary FB₁ shown in the image I to end up with the final segmentation M₁.

As already explained, the classification of a discrepancy EGjm can alternatively be assigned not to the set of pixels/voxels with discrepancy but to a subset of these pixels/voxels, advantageously just a potentially very small subset located in the center of the discrepancy, for example the smallest non-empty set of pixels/voxels after at least one erosion step in at least one dimension of the image.

In these embodiments, the final segmentation Mj of each object can be obtained similarly to step S4 by determining the best visible boundary of the object Aj taking into account the re-classification of a reduced number of disjoint pixels/voxels. The technical effect is to provide a semantically more accurate segmentation precisely aligned to the best visible boundary in the image.

### Curve/Surface (Step S8)

In a complementary manner, in a step S8, a curve/surface Cj delimiting the object Aj in the final image Mj is determined. This is the curve/surface Cj corresponding to a boundary of the image Mj obtained by means of a known algorithm, for example SurfaceNets, Marching Squares/Cubes, Cubical Marching Squares or Flying Edges algorithm.

Indeed, the geodesic defines the most visible single boundary of Aj but the precision of this geodesic is limited by the resolution of the pixels/voxels where the metric of the geodesic is calculated. In particular the visibility indicator given by the CCMF method frames this geodesic with values that are attracted by the pixel/voxel centers and their midpoints.

This curve/surface Cj makes it possible to obtain a contour of the object Aj with a precision in the range of ±0.3 pixel/voxel.

The invention claimed is:

1. A computer-implemented method for segmenting an image, comprising
(S1) obtaining a 2D/3D image I of a region of interest of an element comprising at least one object Aj, j=1 to J, the 2D/3D image I comprising N pixels/voxels In, n=1 to N;
(S2) performing at least one initial segmentation of the 2D/3D image I so as to obtain, for each initial segmentation, J images Pj of segmented object Aj, each image Pj comprising N pixels/voxels Pjn each center of which is a probability of belonging to the object Aj;
(S3) processing each image Pj, from one or several error margins of the corresponding initial segmentation of the image I so as to obtain at least one corresponding image Uj, the image Uj comprising a first area and a second area, the first area comprising only pixels/voxels Ujn which reliably belong to the object, the first area being totally included in the object Aj; the second area comprising only pixels/voxels Ujn which reliably do not belong to the object Aj; the pixels/voxels belonging neither to the first area nor to the second belonging to an area called “uncertain area”;
(S4) processing the pixels/voxels of the 2D/3D image I corresponding to the uncertain area of each image Uj such that the values of the pixels/voxels corresponding to the uncertain area of each image Uj are defined relative to a boundary delimiting the object Aj in the 2D/3D image I in the uncertain area, the boundary being the most visible one in the uncertain area, the pixels/voxels processed in the uncertain area and the pixels/voxels of the first and second areas defining at least one mask Fj; wherein it further comprises:
(S5) determining at least one image Ej of discrepancy between the pixels/voxels Fjn of a mask Fj and the pixels/voxels Pjn of the image Pj, the non-zero pixels/voxels Ejn of the discrepancy image Ej being pixels/voxels with discrepancies, these pixels/voxels being grouped into M disjoint groups EGjm called “discrepancy”, a discrepancy EGjm being a set of pixels/voxels with discrepancy Ejn having the same value different from zero, the discrepancy EGjm and therefore the pixels/voxels with discrepancy Ejn of the discrepancy EGjm being classified as “significant” if the size and/or depth of the set is greater than a threshold E_{MIN} and/or E_{DEPTH} and “not significant” otherwise;
(S7) performing an assignment processing of each pixel/voxel n of each significant discrepancy EGjm of at least one discrepancy image Ej to assign it or not to the object Aj and thus obtain a final segmentation mask Mj comprising a refined segmentation of the object Aj.

2. The method according to claim 1, comprising a step (S6) of classifying each pixel/voxel n of each significant discrepancy EGjm (class S) according to any of the following classes: Inside the object Aj (IN) or outside the object Aj (OUT) by means of a previously trained classification model.

3. The method according to claim 2, wherein the classification takes into account at least one subclass allocated to each significant discrepancy, this subclass being used depending on the use case of the final segmentation Mj to discriminate discrepancies which can be assigned to one or other of the classes depending on the use case.

4. The method according to claim 1, wherein the assignment processing comprises an assignment rule defined in the following manner, for each pixel/voxel n of each significant discrepancy EGjm, if Ejn=1 then Mjn=0, the pixel/voxel Ejn not belonging to the object Aj, if Ejn=−1 then Mjn=1, the pixel/voxel Ejn belonging to the object Aj, the remaining pixels Mjn being identical to the corresponding pixels Fjn of the mask Fj.

5. The method according to claim 1, wherein the processing of each image Pj to obtain an image Uj (S3) consists, for all the pixels/voxels n from 1 to N:
if P_{IN j,n}>P_{HIGH j}, where P_{IN j,n} is the minimum value of the points of the image Pj in a convolution kernel K_{IN j} around the pixel/voxel Pjn of Pj, the pixel/voxel Ujn of the image Uj belongs to the first area;
if P_{OUT j,n}<P_{Low j} where P_{OUT j,n} is the minimum value of the points of the image Pj in a convolution kernel K_{OUT j} around the pixel/voxel Pjn of Pj or if P_{IN k,n}>P_{HIGH k} for k=1 to J where k≠j, the pixel/voxel Ujn of the image Uj belongs to the second area.

6. The method according to claim 5, wherein P_{HIGH j}=½, P_{LOW j}=½ and wherein the pixels/voxels of the first area have a probability equal to 1, the pixels/voxels of the second area have a probability equal to 0, the pixels/voxels of the uncertain area have a probability equal to ½.

7. The method according to claim 1, wherein the most visible boundary (S4) is obtained by processing the 2D/3D image I in the uncertain area by means of a graph cut algorithm, the most visible boundary Fj being the minimum cut of a graph connecting the neighboring pixels/voxels in the uncertain area by links having a capacity defined by a function ƒ of the image I and possibly of the initial segmentation Pj, the minimum cut being obtained by means of an algorithm configured to solve a maximum flow problem.

8. The method according to claim 1, wherein the most visible boundary (S4) is obtained by processing the 2D/3D image I in the uncertain area to obtain a geodesic curve/surface, the geodesic curve/surface being characterized by a function ƒ using the magnitude of the gradient of the image I, the most visible boundary being the one which is the solution to the dual problem of the combinatorial continuous max flow (CCMF) algorithm, solved for example by the Primal-Dual Interior Point (PDIP) algorithm, or an algorithm for solving partial differential equations of the continuous max flow problem of the Appleton-Talbot Continuous Max Flow (AT-CMF) type.

9. The method according to claim 7, wherein the function ƒ uses the magnitude of the gradient of the image I and possibly the magnitude of the gradient of the initial segmentation Pj to discriminate an external boundary of Aj from internal boundary (boundaries) within Aj, for example by using the scalar product of the normalized gradient vectors of Pjn and In, for example with 0<a<1:
$$f ( In , Pjn ) = ‖ \vec{∇} In ‖ \cdot max ( α ; 1 / 2 ( 1 + cos ( \vec{∇} In , \vec{∇} Pjn ) ) ) .$$

10. The method according to claim 1, wherein the determination of each discrepancy image Ej (S5) comprises a binarization of the mask(s) Fj and of the image Pj consisting in obtaining binary images FBj of which each pixel/voxel FBjn is equal to 1 if Fjn>0.5 otherwise 0 and a binary image PBj of which each pixel/voxel PBjn is equal to 1 if Pjn>0.5 otherwise 0, the binary masks being binary versions of the mask(s) Fj and of the image Pj, the discrepancy image Ej comprising pixels/voxels of which the levels are 0, +1 or −1, the uncertain pixels/voxels having a value equal to −1 or +1, the discrepancy image Ej being determined from the binary images FBj and PBj.

11. The method according to claim 10, wherein the discrepancy image Ej includes pixels/voxels Ejn=1 if the pixel/voxel In of the image I is included in the binary mask FBj and out of the binary mask PBj, Ejn=0 if the pixel/voxel In of the image I is included in the mask FBj and in the binary mask PBj or out of the binary mask FBj and the binary mask PBj, Ejn=−1 if the pixel In of the image I is out of the binary mask FBj and included in the image PBj.

12. The method according to claim 10, wherein the assignment rule of step S7 is further defined as follows:

| Value of the pixel/voxel | Class(es) | Value of the |
|---|---|---|
| Ejn of EGjm | of EGjm | pixel/voxel Mjn |
| 1 (in FBj, out of PBj) | S and IN (Inside Aj) | Fjn (>0.5) |
| −1 (out of FBj, in PBj) | S and IN (Inside to Aj) | 1 |
| 1 (in FBj, out of PBj) | S and OUT (Outside Aj) | 0 |
| −1 (out of FBj, in PBj) | S and OUT (Outside Aj) | Fjn (≤0.5) or 0 |

Mjn=1 or >0.5 when the pixel/voxel with discrepancy Ejn belongs to the object Aj and Mjn=0 or ≤0.5 when the pixel/voxel with discrepancy Ejn does not belong to the object Aj, the other remaining pixels/voxels Mjn being identical to the corresponding pixels Fin of the mask Fj.

13. The method claim 1, comprising a step (S8) of determining a curve/surface Cj delimiting the object Aj in the final segmentation mask Mj, the curve/surface Cj corresponding to a boundary in the final segmentation mask Mj obtained by means of a SurfaceNets, Marching Squares/Cubes, Cubical Marching Squares or Flying Edges algorithm.

14. The method according to claim 1, wherein the image I (S1) is a 3D image reconstructed from a number K of 2D images from which the projection parameters are obtained, for example K between 1 and 10, and the boundary (S4) Fj is then determined on an image which is a linear combination of I and the K 2D images back-projected into the space of I according to their respective projection parameters, for example a weighted average where I has a weight equal to K and the K images each have a weight of 1.

15. The method according to claim 1, wherein a plurality of images Ej is determined in step (S5) for each object Aj, step (S5) further comprising the combination of the discrepancy images Ej into a global discrepancy image EΣj, step (S7) being implemented on the basis of each significant discrepancy EΣGjm of said global discrepancy image EΣj.
